(19) United States
(12) Patent Application Publication
(10) Pub. No.: US 2006/0224594 A1
(43) Pub. Date: Oct. 5, 2006

(54) Methods and systems for identifying highly contended blocks in a database

(75) Inventors: Kiran Goyal, Mountain View, CA (US); Tudor Bosman, San Francisco, CA (US); Tirthankar Lahiri, Santa Clara, CA (US)

Correspondence Address: YOUNG LAW FIRM, P.C., 4370 ALPINE RD., STE. 106, PORTOLA VALLEY, CA, 94028, US

(73) Assignee: Oracle International Corporation, Redwood Shores, CA (US)

(21) Appl. No.: 11/099,272

(22) Filed: Apr. 4, 2005

(51) Int. Cl. G06F 17/30

(52) U.S. Cl. 707/10

(57) ABSTRACT

A computer-implemented method of generating a list of K most frequently accessed ones of a plurality of data blocks in a database may include steps of selecting the number K; building the list of K blocks by storing an identification of and maintaining a running count for up to selected K ones of the data blocks by iteratively carrying out a single step for each of the plurality of data blocks, the single step being selected from an incrementing step to increment the count, a decrementing step to decrement the count, an adding step to add a data block to the list and to set a count of the added data block and a replacing step to replace an existing data block of the list with a new data block and to set a count of the new data block, and providing the list of K most frequently accessed blocks.

### BACKGROUND OF THE INVENTION

1. Field of the Invention

The present invention relates to methods and systems for identifying highly contended blocks in a database.

2. Description of the Prior Art and Related Information

When a block of data is being accessed and/or updated, it is said to be “pinned”. As long as the block is pinned, it cannot be accessed or updated by any other process. The accessing or updating process must first release the pinned block before other processes may access it. When another process or thread attempts to access a pinned block, there is said to be contention for the pinned block. Such contention results in delays (also called “sleep states”) as the process or thread wanting to access the pinned block waits for the pinned block to be released. For intensively accessed blocks that result in such delays, this may result in a queue of processes waiting for successive access to the same pinned block or for access to a small number of pinned blocks. There is thus an undesirable latency that is created as the queued processes wait to access the pinned block. This latency naturally increases as the number of processes or threads waiting to access the pinned block, as well as the duration of such wait states.

Moreover, the problem is compounded by the fact that many blocks may reside on a same hash chain. To access a particular block on the hash chain, the entire hash chain may need to be locked. Thereafter, the locked hash chain may need to be traversed and changed. For example, when a block A is pinned within a hash chain, the state of block A may need to be changed, as well as some links in the hash chain. If, for example, another process seeks to access another block B within the locked hash chain, that process must sleep, as it needs to wait for block A to be unpinned before that process may access block B within the locked hash chain. Therefore, a small number of blocks can cause contention on the lock protecting the hash chain.

Typically, a relatively small number of data blocks are responsible for the majority of the latency observed in the system. It is desirable, therefore, to identify those blocks in a hash chain that cause the hash chain to be locked while other processes wait for access to other blocks of the locked hash chain. Often, a histogram of the accesses may resemble a bell curve, with most of the surface area under the curve corresponding to accesses to a relatively few blocks. It has proven to be difficult, however, to identify these “hot blocks” (highly contended data blocks) without imposing an undue computational burden upon the database system. For example, it is unpractical to create a contention statistic (by use a counter, for example) for each block (there may be millions of blocks and many more accesses to such block) in an attempt to determine the blocks that are most frequently accessed blocks that cause contention or delay. Indeed, maintaining such contentions statistics or counters would represent an unacceptable memory overhead in any real-world scenario, as such a scheme would require one memory location for each data block in the database. Moreover, identifying these relatively few hot blocks is important for optimizing the performance of applications that access these blocks. Most of the time, the contention for such hot blocks is only observed from higher-level metrics that are aggregated over a large number of blocks. It is easy to identify which of these sets of blocks is the cause, but hard to “drill down” to the appropriate data block causing the problem.

From the foregoing, it may be appreciated that improved computer-implemented methods and systems for identifying highly contended (hot) blocks in a database system are needed.

### SUMMARY OF THE INVENTION

Embodiments of the present invention include a computer system comprising a database that stores a plurality of files organized as a plurality N of uniquely identified blocks and one or more applications that access selected ones of the blocks, a computer-implemented method of identifying the most frequently accessed blocks in the database comprises steps of: generating a list of the blocks that are accessed by the one or more applications; identifying a selectable number K of blocks from the list that account for at least N/K+1 of the accesses, by carrying out the steps of: setting a first block of the list as an existing candidate block and setting its count to 1; for each subsequent block of the list; carrying out: a step to increment the count of the existing candidate block if the block is identical to an existing candidate block, or if the block is not identical to an existing candidate block, carrying out one of: a step to decrement the count of any existing candidate block having a non-zero count if there are K existing candidate blocks; a step to replace an existing candidate block having a zero count with the block if there are K existing candidate blocks, the block becoming an existing candidate block having a count of 1; a step to add an existing candidate block and setting the count of the added existing candidate block to 1 if there are fewer than K existing candidate blocks, and providing all existing candidate blocks having a non-zero count as the K blocks of the list that account for at least N/K+1 of the accesses.

According to further embodiments, only one step need be carried out for each of the blocks of the generated list. The method may also include a step of assigning a number of memory locations equal to K and storing each existing candidate block in one of the assigned memory locations.

The present invention may also be viewed as a computer system including a database that stores a plurality of files organized as a plurality N of uniquely identified blocks and one or more applications that access selected ones of the blocks, the computer system comprising: at least one processor; a plurality of processes spawned by said at least one processor for identifying the most frequently accessed blocks in the database, the processes including processing logic for: generating a list of the blocks that are accessed by the one or more applications; identifying a selectable number K of blocks from the list that account for at least N/K+1 of the accesses, by carrying out the steps of: setting a first block of the list as an existing candidate block and setting its count to 1; for each subsequent block of the list; carrying out: a step to increment the count of the existing candidate block if the block is identical to an existing candidate block, or if the block is not identical to an existing candidate block, carrying out one of: a step to decrement the count of any existing candidate block having a non-zero count if there are K existing candidate blocks; a step to replace an existing candidate block having a zero count with the block if there are K existing candidate blocks, the block becoming an existing candidate block having a count of 1; a step to add an existing candidate block and setting the count of the added existing candidate block to 1 if there are fewer than K existing candidate blocks, and providing all existing candidate blocks having a non-zero count as the K blocks of the list that account for at least N/K+1 of the accesses.

According to another embodiment thereof is a machine-readable medium having data stored thereon representing sequences of instructions which, when executed by a computing device causes the computing device to identify the most frequently blocks in a database accessed by one or more applications, by carrying out steps including: generating a list of the blocks that are accessed by the one or more applications; identifying a selectable number K of blocks from the list that account for at least N/K+1 of the accesses, by carrying out the steps of: setting a first block of the list as an existing candidate block and setting its count to 1; for each subsequent block of the list; carrying out: a step to increment the count of the existing candidate block if the block is identical to an existing candidate block, or if the block is not identical to an existing candidate block, carrying out one of: a step to decrement the count of any existing candidate block having a non-zero count if there are K existing candidate blocks; a step to replace an existing candidate block having a zero count with the block if there are K existing candidate blocks, the block becoming an existing candidate block having a count of 1; a step to add an existing candidate block and setting the count of the added existing candidate block to 1 if there are fewer than K existing candidate blocks, and providing all existing candidate blocks having a non-zero count as the K blocks of the list that account for at least N/K+1 of the accesses.

According to a still further embodiment, the present invention is a computer-implemented method of generating a list of K most frequently accessed ones of a plurality of data blocks in a database, comprising the steps of: selecting the number K; building the list of K blocks by storing an identification of and maintaining a running count for up to selected K ones of the plurality of accessed data blocks by iteratively carrying out a single step for each of the plurality of data blocks, the single step being selected from an incrementing step to increment the count, a decrementing step to decrement the count, an adding step to add a data block to the list and to set a count of the added data block and a replacing step to replace an existing data block of the list with a new data block and to set a count of the new data block, and providing the list of K most frequently accessed blocks.

The incrementing step may be carried out when the block is identical to one of the selected K ones of the plurality of accessed data blocks. The decrementing step may be carried out when the block has a non-zero count, is not identical to one of the selected K ones of the plurality of accessed data blocks and when a running count for K data blocks is maintained. The adding step may be carried out when the block is not identical to one of the selected K ones of the plurality of accessed data blocks, and when a running count for fewer than K data blocks is maintained. The replacing step may be carried out when the block has a zero count, is not identical to one of the selected K ones of the plurality of accessed data blocks, and when a running count for K data blocks is maintained.

The present invention, according to another embodiment thereof, is a computer system suitable for generating a list of K most frequently accessed ones of a plurality of data blocks in a database, comprising: at least one processor; a plurality of processes spawned by said at least one processor, the processes including processing logic for: enabling a selection of the number K; building the list of K blocks by storing an identification of and maintaining a running count for up to selected K ones of the plurality of accessed data blocks by iteratively carrying out a single step for each of the plurality of data blocks, the single step being selected from an incrementing step to increment the count, a decrementing step to decrement the count, an adding step to add a data block to the list and to set a count of the added data block and a replacing step to replace an existing data block of the list with a new data block and to set a count of the new data block, and providing the list of K most frequently accessed blocks.

The present invention may also be viewed, according to one embodiment thereof, as a machine-readable medium having data stored thereon representing sequences of instructions which, when executed by computing device, causes said computing device to generate a list of K most frequently accessed ones of a plurality of data blocks in a database, by performing the steps of: enabling a selection of the number K; building the list of K blocks by storing an identification of and maintaining a running count for up to selected K ones of the plurality of accessed data blocks by iteratively carrying out a single step for each of the plurality of data blocks, the single step being selected from an incrementing step to increment the count, a decrementing step to decrement the count, an adding step to add a data block to the list and to set a count of the added data block and a replacing step to replace an existing data block of the list with a new data block and to set a count of the new data block, and providing the list of K most frequently accessed blocks.

### BRIEF DESCRIPTION OF THE DRAWINGS

FIG. 1 is a flowchart illustrating a method for identifying highly contended blocks, according to an embodiment of the present invention.

FIG. 2 is a flowchart illustrating aspects of a method for identifying highly contended blocks, according to an embodiment of the present invention.

FIG. 3 shows a first example of a method for identifying highly contended blocks, according to an embodiment of the present invention.

FIG. 4 shows a second example of a method for identifying highly contended blocks, according to an embodiment of the present invention.

FIG. 5 is a block diagram of a computer with which embodiments of the present invention may be practiced.

### DETAILED DESCRIPTION

Embodiments of the present invention provide methods and systems for identifying highly contended blocks in a manner that is economical in terms of processing and memory resources. Embodiments of the present invention generate a list of K candidate hot blocks from among all blocks in the database. If one or more of the blocks in the database cause more than N/K+1 of all N data accesses each (and are thus candidates for being characterized as being highly contended), such blocks will be among the K blocks generated. The memory requirement to generate the list of K candidate hot blocks is proportional to K (usually a small number such as, for example, less than 100) and not to the total number of blocks in the database or the total number of blocks accessed by the application(s).

According to an embodiment of the present invention, the list of K candidate hot blocks may include only those blocks that are accessed N/K+1 percent of the time. For example, if it is desired to find that block that is accessed over 50% of the time (if there is such a block), K would be set to 1, such that the list K candidate blocks includes only that block that is accessed more frequently than N/2 of all accesses. As alluded to above, such a block may not exist. A more useful K might be, for example, 10-20, such that the list of candidate hot blocks generated includes only blocks that are accessed more than 10% of all accesses (K=10) or, for example, only blocks that are accessed more than 5% of all accesses (K=20). Similarly, if K is chosen to be equal to 99, the list of candidate hot blocks will include all blocks that are the target of at least 1% of all accesses to the N blocks within the database (or to the N blocks normally accessed by the application(s)). Note that the list of candidate hot blocks does not guarantee that all blocks listed therein are highly contended, only that the most highly contended blocks are present within the generated list.

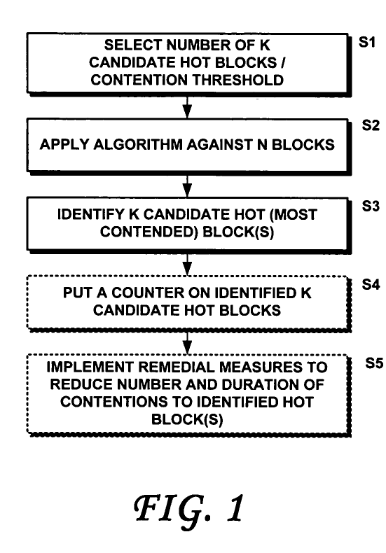

FIG. 1 is a flowchart illustrating an embodiment of a method for identifying highly contended blocks, according to an embodiment of the present invention. As shown therein, step S1 calls for a selection of the number K. K may be thought of as the number of blocks within the list of candidate hot blocks to be generated. As shown, step S2 calls for the application of the method described herein to discern which among the N blocks is/are the target of at least N/K+1 accesses to the database. The result of the application of the method of S2 is a list of candidate hot blocks, as suggested by S3. This list of candidate hot blocks may then be further scrutinized to determine which of the listed blocks are, indeed, highly contended. This may be carried out, for example, by using a counter for each of the identified candidate hot blocks. The computational and memory overhead for such counters is believed to be low, as only 10 or fewer counters need be deployed, in the case wherein K=9, for example. Thereafter, application developers may utilize this information to optimize their application (or to mitigate the effects of contention for pinned blocks), armed with the knowledge of which, among the N blocks of the database, are the most highly contended. These identified most highly contended blocks may, therefore, be responsible for most of the latency that is created as the queued processes wait to access the contended pinned block.

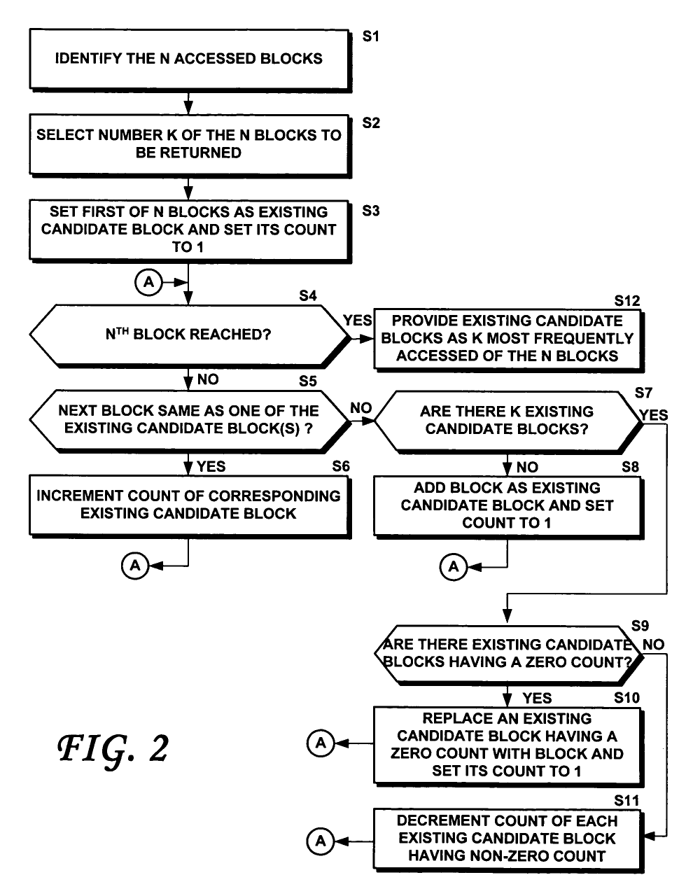

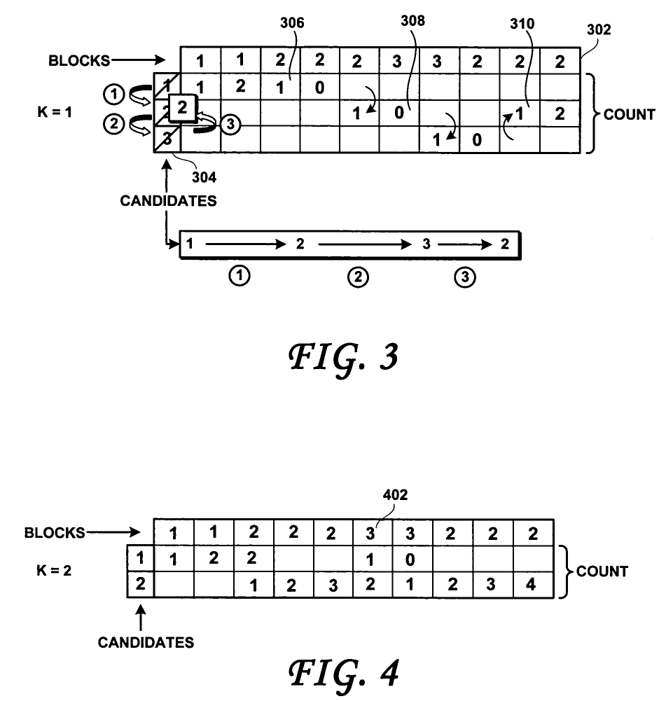

FIG. 2 is a flowchart illustrating aspects of a method for identifying highly contended blocks, according to an embodiment of the present invention. As shown therein, step S1 calls for the identification of the N blocks that are accessed (in the case of the examples worked out in FIGS. 3 and 4, the N blocks are 1, 1, 2, 2, 2, 3, 3, 2, 2, 2). Note that N, in real applications, would be much greater, typically counting thousands or millions of accesses. A number K of the most contended blocks to be generated is then selected, as suggested at S2 in FIG. 2. Step S3 calls the setting the first of the N blocks as an existing candidate block and setting its count to 1. At S4, it is checked whether the N^{th} block has been reached. If not, the method proceeds to step S5, whereupon it is determined whether the next block is the same as one of the existing candidate blocks. Note that if K is selected to be one, there can only be a single existing candidate block, whereas if K is selected to be greater than one, K>1 there may be up to K>1 existing candidate blocks. If the next block is the same as the or one of the existing candidate blocks (YES branch of S5), the count of the corresponding existing candidate block is incremented, as called for by step S6. The method then reverts to S4, as indicated by A. If, however, the next block is not the same as the or one of the existing candidate blocks (NO branch of S5), it may then be determined whether there are K existing candidate blocks, as shown at S7. For example, even through K=15, there may be fewer than 15 existing candidate blocks. If there are not K existing candidate blocks, step S8 may be carried out, and the current block may be set as a (new) existing candidate block and its count set to 1. The method may then revert back to S4, as suggested by the letter A. If, however, there are fewer than K existing candidate blocks (there cannot be a greater number than K existing candidate blocks) as shown at the YES branch of S7, it may then be determined whether there are any existing candidate blocks having a zero count, as shown at S9. If not (NO branch of S8), the count of each existing candidate block having a non-zero count is decremented, as shown at S11, whereupon the method may revert to step S4. If, however, there are existing candidate blocks having a zero count (Yes branch of S9), the current block replaces one of the existing zero-count candidate blocks and the count of the new existing candidate block is set to 1, as called for by S10. The method may then return to step S4. When the N^{th} block is reached at the NO branch of S4, the then existing candidate block or blocks may be provided, as called for by step S12. The resultant list of provided candidate blocks are or include the most highly contended blocks. The developer may then wish to further investigate whether these blocks are, indeed, highly contended and the cause of a significant number of delays (sleeps) as processes attempt to access blocks while they are in a pinned state. For example, a counter process may be used to monitor each of the provided blocks, to measure the number of accesses thereto accesses empirically. Note that the list of most highly contended block candidates provided at S12 is generated by carrying out a single pass through the identified N blocks, carrying out the above-described steps. Moreover, the memory usage is proportional to K, and not to N. Consequently, this method is effective to return a list of candidate hot blocks in a highly efficient manner, both in terms of processing and memory resources.

FIG. 3 shows a first example of an embodiment of a method for identifying highly contended blocks, according to an embodiment of the present invention. FIG. 3 shows a vastly simplified example, in which the set of N blocks only comprises 10 blocks and K=1. However, it is understood that the methods described herein may be readily scaled to most any number of block accesses. In this example, the list of candidate highly contended block will include only that block (if it exists) that is the target of over N/K+1 accesses, or 5 accesses—in this case, 50% of all 10 (N=10) accesses.

As shown in the representation of FIG. 3, the top row 202 identifies the 10 blocks accessed, whereas column 304 contains the current hot block candidate. Although FIG. 1 shows three rows below the top row 302, when K=1, there is only one candidate that exists at a time, these three rows only being shown to show intermediate results, as the list of N accesses are traversed to generate the list of K candidate highly contended blocks. In this example, the list will only include a single element. According to embodiments of the present invention, a first step may be necessary to identify those N blocks that have been accessed and a single pass through the N blocks may be carried out to identify that or those blocks among the N blocks that the most highly contended, according to the K criteria chosen. As shown in FIG. 3, the blocks accessed are blocks identified as 1, 1, 2, 2, 2, 3, 3, 2, 2, 2. From inspection, it is apparent that the block identified as block 2 is the most frequently accessed. However, embodiments of the present invention find greater utility when a large number of blocks (on the order of millions of blocks, for example) need to be examined in an efficient manner to find those few blocks that are responsible for most of the latency experienced due to block contention.

Working the example of FIG. 3, the first accessed block (block 1) is set as the first candidate block. This candidate block's count is set at 1, meaning that access to candidate block 1 has occurred one time. According to an embodiment of the present invention, when the accessed block is the same as an existing candidate block, the count for that existing candidate block is incremented. The next (i.e., second) block accessed is again block 1. Applying the above rule, candidate 1's count is, therefore, incremented and its count is now 2. The next block accessed is block 2. According to embodiments of the present invention, whenever an accessed block is not the (K=1) or not one of the (K>1) existing candidate blocks, all counts of existing candidate blocks that are greater than 0 are decremented. If, however, the count for any existing candidate block is 0, and the accessed block is not one of the existing candidate blocks, the accessed block replaces a previous candidate having a 0 count and the accessed block becomes a new candidate block and its count is set to 1. In this case, the count for candidate 1 is decremented as shown at 306, since accessed block 2 is not the existing candidate block and the existing candidate block (i.e., block 1) has a non-zero count. The next accessed block is block 2, and the candidate block 1's count is decremented to 0, for the same reasons as the previous decrement at 306. Continuing with the example, the next accessed block is again block 2. Since block 2 is not the existing candidate block and the existing candidate block's count is zero, block 2 replaces candidate block 1 and becomes the next candidate block, as shown by (1) and the crossed out block 1 in column 304 in FIG. 3.

As shown at 308, the next block accessed is block 3, which causes existing candidate block 2's count to be decremented to zero, as shown at 308. Thereafter, block 3 is again accessed. As shown by (2), since block 3 is not the existing candidate block (block 2 is) and the block 2's count is zero, block 3 replaces candidate block 2 and becomes the next candidate block (block 2 in column 304 is crossed out, to suggest that it is no longer the existing candidate block). The next accessed block is 2, which decrements existing candidate block 3's count to zero. As shown at 310, the next accessed block is again 2. Since block 2 is not the existing candidate block (block 3 is) and the block 3's count is zero, block 2 replaces candidate block 3 as shown at (3) and block 2 again becomes the next candidate block, with a count of 1. The last accessed block in this simplified example is again block 2, which simply causes existing candidate block 2's count to be incremented to 2. According to an embodiment of the present invention, that block 2 is the last existing candidate block and has a non-zero count, if any block is accessed greater than N/2 times (i.e., greater than 50% of the time), it must be block 2, although it is understood that no such block may exist. However, if such a block does exist, it must be block 2.

Thereafter, it is a simple matter for the application developer to track accesses to block 2 to determine the frequency of access thereto by means of, for example, a counter. Armed with this knowledge, the application developer may choose to change the manner in which block 2 is accessed and/or take other remedial programmatic measures to prevent or reduce contention on block 2 and the associated consequential delays. Therefore, instead of having to measure access to all N blocks (potentially numbering in the millions), embodiments of the present invention enable developers to identify potentially highly contended blocks by measuring accesses to K blocks, where K<<N. For example, K may be chosen to be, for example, 20, in which case, embodiments of the present invention may return a list of candidate blocks, the accesses to which may account for at least 5% of all accesses to the N blocks.

FIG. 4 shows a second example of an embodiment of a method for identifying highly contended blocks, according to an embodiment of the present invention. Note that FIG. 4 uses the same 10 accesses as does the example of FIG. 3. However, K is chosen to be 2 in FIG. 4, meaning that the result will identify a candidate block or at most two candidate blocks that account for greater than one third of all accesses. When K is set to a number greater than 1, more than one candidate blocks can exist simultaneously, as demonstrated below. As shown, the first block accessed is block 1, which then becomes the first candidate block, and its count is set at 1. The next accessed block is, as in FIG. 3, block 2, which causes existing candidate block 1's count to be incremented to 2. The next block accessed is block 2. Since K=2, block 2 is allowed to become the other existing candidate block and its count is set to 1. The next two accessed blocks are 2, which causes existing candidate block 2's count to be incremented twice, to a count of 3. As shown at 402, the next accessed block is block 3. As noted above, whenever an accessed block is not one of the existing candidate blocks (in this case, existing candidate blocks 1 and 2), all non-zero counts of existing candidate blocks are decremented. Therefore, the count for both existing candidate block 1 and existing candidate block 2 is decremented. The next accessed block is again block 3 and the count for existing candidate blocks 1 and 2 are again decremented. The next and last three block accesses are to block 2, which is an existing candidate block. Therefore, existing candidate block 2's count is incremented three times to 4. After having traversed the array of accessed blocks, the count for existing candidate block 1 is zero and the count for existing candidate block 2 is 4. It is clear that, if such a block exists, the block of the N blocks that accounts for over ⅓ of all accesses to the N blocks must be block 2. The same measures may be taken relative to block 2 as were described relative to block 2, to confirm that block 2 is indeed accessed that frequently and to develop some programmatic remediation to alleviate (reduce or eliminate) the frequency and duration of such contentions to access block 2.

As may be appreciated, embodiments of the present invention may be implemented with very little memory, and have low runtime overhead. Indeed, the memory requirements are only proportional to K, and not to N, the total number of accesses. In fact, an embodiment of the present invention may run continuously without appreciably degrading performance on a production system.

Note that the methods herein need not be invoked for each access. For example, when a process holds and locks a hash chain, it may write into the lock an identification of the block within that hash chain that caused the process to hold the hash chain. When a process sleeps, it may read the lock to determine the identification of the block for which the hash chain is being locked. That identified block may then be included into the list of blocks on which the methods described herein may be practiced. In this manner, the list on which the methods described herein are implemented need include only those blocks that have caused sleep or wait states, and need not include all of the blocks accessed for which there is no contention. The resource overhead for practicing embodiments of the present invention may be, therefore, proportional only to the number of sleeps, and not to the number of accesses. For example, a block A may be accessed a million times by a single process during the first ten minutes of a run. This should not cause any contention, because only a single process is accessing block A. During the last ten minutes or the run, for example, ten processes may access blocks B and C one thousand times each. In this case, it is likely that blocks B and C are the cause of contention, and not the most frequently accessed block, block A.

Embodiments and uses of the present invention are not limited to instances where blocks are pinned and unpinned or limited to identifying block contention. Indeed, embodiments and uses of the present inventions may be extended to instances where contention is caused by any number of reasons for which the memory and/or other computational resources required to pinpoint the cause of the contention is quite large.

Embodiments of the present invention may produce false positives. That is, the method described herein may return candidate blocks that do not satisfy the threshold; that is, that do not account for more than N/K+1 of the accesses to the N blocks. However, if such highly contended blocks that do satisfy that threshold exist, they will be among the blocks returned. According to embodiments of the present invention, the candidate blocks identified as being potential highly contended blocks are preferably checked to determine whether they actually are the cause of contention. This may readily be implemented by adding a per-block counter statistic for those K blocks returned by the present method. Embodiments of the present invention enable performance problems much easier to diagnose, and does so in a manner that is not onerous in terms of memory and processor overhead.

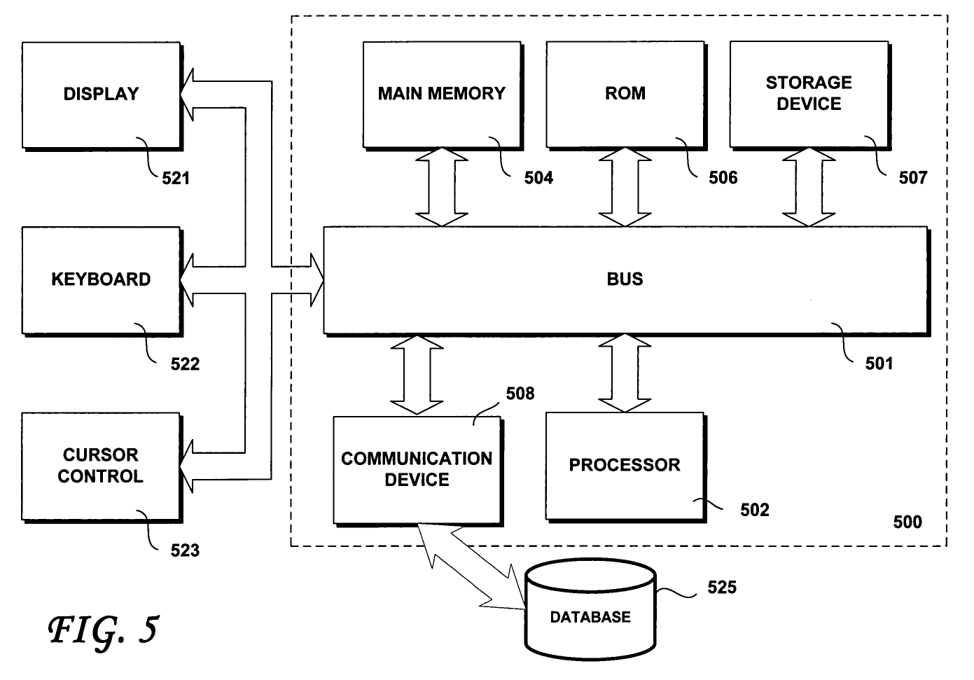

FIG. 5 illustrates a block diagram of a computer system 500 upon which embodiments of the present inventions may be implemented. Computer system 500 includes a bus 501 or other communication mechanism for communicating information, and one or more processors 502 coupled with bus 501 for processing information. Computer system 500 further comprises a random access memory (RAM) or other dynamic storage device 504 (referred to as main memory), coupled to bus 501 for storing information and instructions to be executed by processor(s) 502. Main memory 504 also may be used for storing temporary variables or other intermediate information during execution of instructions by processor 502. Computer system 500 also includes a read only memory (ROM) and/or other static storage device 506 coupled to bus 501 for storing static information and instructions for processor 502. A data storage device 507, such as a magnetic disk or optical disk, is coupled to bus 501 for storing information and instructions. The computer system 500 may also be coupled via the bus 501 to a display device 521 for displaying information to a computer user. An alphanumeric input device 522, including alphanumeric and other keys, is typically coupled to bus 501 for communicating information and command selections to processor(s) 502. Another type of user input device is cursor control 523, such as a mouse, a trackball, or cursor direction keys for communicating direction information and command selections to processor 502 and for controlling cursor movement on display 521. A microphone may be used to provide verbal input, and cameras may be used to input user gestures or sign language, as shown at 525.

Embodiments of the present invention are related to the use of computer system 500 and/or to a plurality of such computer systems to enable methods and systems for identifying highly contended blocks in a database, such as shown at 525 in FIG. 5. According to one embodiment, the methods and systems described herein may be provided by one or more computer systems 500 in response to processor(s) 502 executing sequences of instructions contained in memory 504. Such instructions may be read into memory 504 from another computer-readable medium, such as data storage device 507. Execution of the sequences of instructions contained in memory 504 causes processor(s) 502 to perform the steps and have the functionality described herein. In alternative embodiments, hard-wired circuitry may be used in place of or in combination with software instructions to implement the present invention. Thus, the present invention is not limited to any specific combination of hardware circuitry and software.

While the foregoing detailed description has described preferred embodiments of the present invention, it is to be understood that the above description is illustrative only and not limiting of the disclosed invention. Those of skill in this art will recognize other alternative embodiments and all such embodiments are deemed to fall within the scope of the present invention. For example, the panels described herein may be omitted or replaced with another visual device. Other modifications will occur to those of skill in this art. Thus, the present invention should be limited only by the claims as set forth below.

What is claimed is:

1. In a computer system comprising a database that stores a plurality of files organized as a plurality N of uniquely identified blocks and one or more applications that access selected ones of the blocks, a computer-implemented method of identifying the most frequently accessed blocks in the database comprises steps of:
generating a list of the blocks that are accessed by the one or more applications;
identifying a selectable number K of blocks from the list that account for at least N/K+1 of the accesses, by carrying out the steps of:
setting a first block of the list as an existing candidate block and setting its count to 1;
for each subsequent block of the list; carrying out:
a step to increment the count of the existing candidate block if the block is identical to an existing candidate block, or if the block is not identical to an existing candidate block, carrying out one of:
a step to decrement the count of any existing candidate block having a non-zero count if there are K existing candidate blocks;
a step to replace an existing candidate block having a zero count with the block if there are K existing candidate blocks, the block becoming an existing candidate block having a count of 1;
a step to add an existing candidate block and setting the count of the added existing candidate block to 1 if there are fewer than K existing candidate blocks; and
providing all existing candidate blocks having a non-zero count as the K blocks of the list that account for at least N/K+1 of the accesses.

2. The computer-implemented method of claim 1, wherein only one step is carried out for each of the blocks of the generated list.

3. The computer-implemented method of claim 1, further comprising a step of assigning a number of memory locations equal to K and storing each existing candidate block in one of the assigned memory locations.

4. A computer system including a database that stores a plurality of files organized as a plurality N of uniquely identified blocks and one or more applications that access selected ones of the blocks, the computer system comprising:
at least one processor;
a plurality of processes spawned by said at least one processor for identifying the most frequently accessed blocks in the database, the processes including processing logic for:
generating a list of the blocks that are accessed by the one or more applications;
identifying a selectable number K of blocks from the list that account for at least N/K+1 of the accesses, by carrying out the steps of:
setting a first block of the list as an existing candidate block and setting its count to 1;
for each subsequent block of the list; carrying out:
a step to increment the count of the existing candidate block if the block is identical to an existing candidate block, or if the block is not identical to an existing candidate block, carrying out one of:
a step to decrement the count of any existing candidate block having a non-zero count if there are K existing candidate blocks;
a step to replace an existing candidate block having a zero count with the block if there are K existing candidate blocks, the block becoming an existing candidate block having a count of 1;
a step to add an existing candidate block and setting the count of the added existing candidate block to 1 if there are fewer than K existing candidate blocks; and
providing all existing candidate blocks having a non-zero count as the K blocks of the list that account for at least N/K+1 of the accesses.

5. A machine-readable medium having data stored thereon representing sequences of instructions which, when executed by a computing device causes the computing device to identify the most frequently blocks in a database accessed by one or more applications, by carrying out steps including:
generating a list of the blocks that are accessed by the one or more applications;
identifying a selectable number K of blocks from the list that account for at least N/K+1 of the accesses, by carrying out the steps of:
setting a first block of the list as an existing candidate block and setting its count to 1;
for each subsequent block of the list; carrying out:
a step to increment the count of the existing candidate block if the block is identical to an existing candidate block, or if the block is not identical to an existing candidate block, carrying out one of:
a step to decrement the count of any existing candidate block having a non-zero count if there are K existing candidate blocks;
a step to replace an existing candidate block having a zero count with the block if there are K existing candidate blocks, the block becoming an existing candidate block having a count of 1;
a step to add an existing candidate block and setting the count of the added existing candidate block to 1 if there are fewer than K existing candidate blocks, and
providing all existing candidate blocks having a non-zero count as the K blocks of the list that account for at least N/K+1 of the accesses.

6. A computer-implemented method of generating a list of K most frequently accessed ones of a plurality of data blocks in a database, comprising the steps of:
selecting the number K;
building the list of K blocks by storing an identification of and maintaining a running count for up to selected K ones of the plurality of accessed data blocks by iteratively carrying out a single step for each of the plurality of data blocks, the single step being selected from an incrementing step to increment the count, a decrementing step to decrement the count, an adding step to add a data block to the list and to set a count of the added data block and a replacing step to replace an existing data block of the list with a new data block and to set a count of the new data block, and
providing the list of K most frequently accessed blocks.

7. The computer-implemented method of claim 6, wherein the incrementing step is carried out if the block is identical to one of the selected K ones of the plurality of accessed data blocks.

8. The computer-implemented method of claim 6, wherein the decrementing step is carried out when the block has a non-zero count, is not identical to one of the selected K ones of the plurality of accessed data blocks and when a running count for K data blocks is maintained.

9. The computer-implemented method of claim 6, wherein the adding step is carried out when the block is not identical to one of the selected K ones of the plurality of accessed data blocks, and when a running count for fewer than K data blocks is maintained.

10. The computer-implemented method of claim 6, wherein the replacing step is carried out when the block has a zero count, is not identical to one of the selected K ones of the plurality of accessed data blocks, and when a running count for K data blocks is maintained.

11. A computer system suitable for generating a list of K most frequently accessed ones of a plurality of data blocks in a database, comprising:
at least one processor;
a plurality of processes spawned by said at least one processor, the processes including processing logic for:
enabling a selection of the number K;
building the list of K blocks by storing an identification of and maintaining a running count for up to selected K ones of the plurality of accessed data blocks by iteratively carrying out a single step for each of the plurality of data blocks, the single step being selected from an incrementing step to increment the count, a decrementing step to decrement the count, an adding step to add a data block to the list and to set a count of the added data block and a replacing step to replace an existing data block of the list with a new data block and to set a count of the new data block, and
providing the list of K most frequently accessed blocks.

12. A machine-readable medium having data stored thereon representing sequences of instructions which, when executed by computing device, causes said computing device to generate a list of K most frequently accessed ones of a plurality of data blocks in a database, by performing the steps of:
enabling a selection of the number K;
building the list of K blocks by storing an identification of and maintaining a running count for up to selected K ones of the plurality of accessed data blocks by iteratively carrying out a single step for each of the plurality of data blocks, the single step being selected from an incrementing step to increment the count, a decrementing step to decrement the count, an adding step to add a data block to the list and to set a count of the added data block and a replacing step to replace an existing data block of the list with a new data block and to set a count of the new data block, and
providing the list of K most frequently accessed blocks.
